(19) United States
(12) Patent Application Publication
(10) Pub. No.: US 2024/0127171 A1
(43) Pub. Date: Apr. 18, 2024

(54) SYSTEM FOR IDENTIFYING PRODUCT SUBSTITUTES FIELD

(71) Applicant: WESCO Distribution, Inc., Pittsburgh, PA (US)

(72) Inventors: Shashi Bhushan DANDE, Spring, TX (US); Raja Vikram Raj PANDYA, Katy, TX (US); Ashok Ramesh BAJAJ, Katy, TX (US); Michael Gregg WASSIL, Pittsburgh, PA (US); Avinash WESLEY, New Caney, TX (US); Vipul PANT, Dehradun (IN); Sanjay VARIER, Bangalore (IN); Merwan MEREBY, Denville, NJ (US); Benjamin James ALBU, Pittsburgh, PA (US); Akash KHURANA, Houston, TX (US); Hemant PORWAL, Sewickley, PA (US); Brandon Lee PHILLIPS, Grayslake, IL (US); Michael SENOL, Gurnee, IL (US)

(73) Assignee: WESCO Distribution, Inc., Pittsburgh, PA (US)

(21) Appl. No.: 17/968,039

(22) Filed: Oct. 18, 2022

(51) Int. Cl. G06Q 10/087

(52) U.S. Cl. CPC G06Q 10/087

(57) ABSTRACT

A product management computer system that can include one or more processors, and a computer-readable medium comprising instructions stored therein, which when executed by the processors, can cause the processors to: receive data representing a target product of interest to a user of the system, wherein the target product is described by a plurality of variable-value attributes associated; process the received data through a machine-learning-produced algorithm and generating data representing a first set of substitute product candidates for the target product and wherein each substitute product candidate has a corresponding match-score that represents a degree of determined similarity between that substitute product candidate and the target product; transform the generated data that represents the first set of substitute product candidates into data representing a refined set of substitute product candidates by processing the generated data utilizing a constraint-based algorithm; and output data representing the refined set of substitute product candidates.

This disclosure relates generally to refining substitute products for a target product, and more specifically, to constraint-based refinement of a set of substitute products for a target product.

### BACKGROUND

Today's product substitution methods depend on outdated systems and inefficient procedures to identify substitute products for a target product of interest. Current product management systems do not allow for easy customization or the necessary functionality to facilitate optimal product substitution. While current systems permit some customization, this customization is time consuming and costly to implement. These customizations must generally be hard coded into the application by the developer, thereby incurring increases in costs, delay in implementation, and loss of productivity. Additionally, conventional order substitution methods do not meet the growing need for evaluating and weighing a variety of product substitution factors in combination with business considerations in a cost efficient and timely manner.

For example, in the field of product management, a distributor that sources ordered products and/or services for their customers typically has contractual relationships with multiple vendors/suppliers to provide products and services for sale by the distributor. Each contractual relationship typically comprises terms on price, delivery, discounts and other business considerations. Implementation of the terms can become complex when certain terms influence other terms. As an example, discount rates are typically based on purchase volume by the distributor from the supplier, regardless to whom the distributor sells the supplied products and services. As these contractual relationships become more complex, factoring these terms into a product management system also becomes more complex, especially when multiple suppliers are considered. Product management systems do not currently allow users to perform this function in tandem with evaluating functional aspects of a target product and acceptable substitution product(s) for that target product. These shortcomings of conventional product management systems decrease the likelihood of an optimal product substitution.

### BRIEF DESCRIPTION OF THE DRAWINGS

In order to describe the manner in which the above-recited and other advantages and features of this disclosure can be obtained, a more particular description of the principles briefly described above will be rendered by reference to specific embodiments thereof which are illustrated in the drawings that accompany this disclosure. The drawings depict exemplary embodiments of the technology described in the present disclosure but are not limiting in scope thereto; further, certain principles disclosed herein are described and explained with additional specificity and detail through the use of the accompanying drawings in which:

FIG. 1 is a block diagram of a system depicting interacting functional modules for identifying substitute products for a target product via a distributor's product management computer system in accordance with an example implementation of the present technology;

FIG. 2 is a flow diagram of a method of identifying substitute products for a target product via a distributor's product management computer system, in accordance with an example implementation of the present technology;

FIG. 3 illustrates an example algorithm engine process that can be implemented in examples disclosed herein;

FIG. 4 illustrates an example initial product search process that can be implemented in examples disclosed herein;

FIG. 5 illustrates an example final product filtering and ranking process that can be implemented in examples disclosed herein;

FIG. 6A illustrates an example flow for utilizing fuzzy matching to identify substitute products for a target product that can be implemented in examples disclosed herein;

FIG. 6B illustrates an example flow for implementing substitute algorithms for identifying substitute products of a target product that can be implemented in examples disclosed herein; and

FIG. 7 depicts an exemplary processor-based computing system suitable for use as a platform for executing certain routines of the presently disclosed AI/ML modeling.

### DETAILED DESCRIPTION

Various embodiments of the currently disclosed technology is discussed in greater detail hereinbelow. While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring important aspects of the technology.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others.

The terms used in this specification generally have their ordinary meanings in the art, within the context of the disclosure, and in the specific context where each term is used. Alternative language and synonyms may be used for any one or more of the terms discussed herein, and no special significance should be placed upon whether a term is elaborated or discussed herein. In some cases, synonyms for certain terms are provided. A recital of one or more synonyms does not exclude the use of other synonyms. The use of examples in this specification are for illustrative purposes only, and is not intended to limit the scope of the disclosure. Likewise, the disclosure is not limited to the various embodiments described in this specification.

Without intent to limit the scope of the disclosure, examples of instruments, apparatus, methods and their related results according to the embodiments of the present disclosure are given below. Note that titles or subtitles may be used in the examples for convenience of the reader, but which in no way limit the scope of the disclosure. Unless otherwise defined, technical and scientific terms used herein have the meaning as commonly understood by one of ordinary skill in the art to which this disclosure pertains. In the case of conflict, the present document, including definitions control.

Additional features and advantages of the disclosed technology are set forth in the description which follows, and others will be obvious from the description or can be learned by practicing the principles described herein. The features and advantages of the disclosure can be realized and obtained by means of the instruments and combinations particularly pointed out in the appended claims. These and other features of the presently disclosed technology will become more fully apparent from the following description and appended claims, or can be learned by the practice of the principles set forth herein.

Overview

The presently disclosed technology comprises (includes, but is not necessarily limited to) a computer implemented method for identifying substitute products for a target product (a particular product identified for look-up) via a distributor's product management computer system. The method includes receiving, at the distributor's product management computer system, data representing a target product of interest to a user of the system. Examples of such users can include customers of the distributor and/or sales representatives within the distributor. The target product is described by a plurality (two or more) of variable-value attributes associated therewith. In this regard, a “variable-value attribute” is an aspect of the product that can have different values. An example is light bulb wattage. That is, all light bulbs have a “wattage” attribute/rating, but the value of the variable-value attribute (wattage) can vary across different, but otherwise similar light bulbs. Another example of light bulb “variable-value attribute” is type, such as incandescent versus Light Emitting Diode (LED).

The disclosed method further includes processing the received data through a machine-learning-produced algorithm (model) and thereby generating data representing a first set of substitute product candidates for the target product and wherein each substitute product candidate has a corresponding match-score that represents a degree of determined similarity between that substitute product candidate and the target product. Further, the method includes transforming the generated data that represents the first set of substitute product candidates into data representing a refined set of substitute product candidates by processing the generated data (that defines the first set of substitute product candidates) utilizing a constraint-based algorithm (imposing required criteria) that filters the first set of substitute product candidates to those that meet the criteria of the constraint-based algorithm. The constraint can be based on respective match-scores of each substitute product candidate in the first set of substitute product candidates. Finally, the method includes outputting data representing the refined set of substitute product candidates.

A distributor's product management computer system can include one or more processors and a computer-readable medium comprising instructions stored therein, which when executed by the one or more processors, cause the one or more processors to receive data representing a target product of interest to a user of the system, wherein the target product is described by a plurality of variable-value attributes associated therewith. The instructions can also cause the one or more processors to process the received data through a machine-learning-produced algorithm and thereby generating data representing a first set of substitute product candidates for the target product and wherein each substitute product candidate has a corresponding match-score that represents a degree of determined similarity between that substitute product candidate and the target product. Additionally, the instructions can cause the one or more processors to transform the generated data that represents the first set of substitute product candidates into data representing a refined set of substitute product candidates by processing the generated data utilizing a constraint-based algorithm (imposing required criteria) that filters the first set of substitute product candidates to those that meet the criteria of the constraint-based algorithm. The constraint can be based on respective match-scores of each substitute product candidate in the first set of substitute product candidates. Finally, the instructions can cause the one or processors to output data representing the refined set of substitute product candidates.

A non-transitory computer-readable storage medium comprising instructions stored therein, which when executed by one or more processors, cause the one or more processors to receive, in a distributor's product management computer system, data representing a target product of interest to a user of the system, wherein the target product is described by a plurality of variable-value attributes associated therewith. The instructions can also cause the one or more processors to process the received data through a machine-learning-produced algorithm and thereby generating data representing a first set of substitute product candidates for the target product and wherein each substitute product candidate has a corresponding match-score that represents a degree of determined similarity between that substitute product candidate and the target product. Additionally, the instructions can cause the one or more processors to transform the generated data that represents the first set of substitute product candidates into data representing a refined set of substitute product candidates by processing the generated data utilizing a constraint-based algorithm (imposing required criteria) that filters the first set of substitute product candidates to those that meet the criteria of the constraint-based algorithm. The constraint can be based on respective match-scores of each substitute product candidate in the first set of substitute product candidates. Finally, the instructions can cause the one or processors to output data representing the refined set of substitute product candidates.

### DESCRIPTION

As discussed previously, known product substitution methods typically use outdated systems and inefficient procedures in identifying substitute products for a target product. Current product management systems do not allow for easy customization or the necessary functionality to facilitate optimal product substitution. While current systems permit some customization, this customization is time consuming and costly to implement. These customizations must generally be hard coded into the application by the developers, thereby incurring increased costs, delays in implementation, and loss of productivity. Additionally, conventional order substitution methods do not meet the growing need for evaluating and weighing a variety of product substitution factors in combination with business considerations in a cost efficient, timely manner.

For example, in the field of product management, a distributor in need of a product or service generally has contractual relationships with multiple vendors to provide the desired product or service. The contractual relationship may define such terms as price, delivery, amount of discount, and other business considerations. These terms can become complex as one term can influence other terms, such as different levels of discounts based on the number of items ordered. As these contractual relationships become more complex, factoring these terms into a product management system also becomes more complex. Product management systems do not currently allow users to perform this function in tandem with evaluating functional aspects of the target product and substitutions. These shortcomings of conventional product management systems decrease the likelihood of obtaining an optimal product substitution. Therefore, there is a need for systems and methods that can provide a holistic product management system.

The present disclosure includes systems, methods, and computer-readable media for solving these problems/inferiorities. Specifically, the present technology includes systems, methods, and computer-readable media that facilitate systematic identification of substitute products for a target product based upon predetermined criteria and set processes, such that the substitutions are made in a manner that increases or otherwise optimizes efficiency.

Further, the present technology facilitates identification of product substitutions compatible with the target product's functional aspects to ensure a more desirable product recommendation. More specifically, the present technology facilitates product substitutions based upon predetermined criteria and set processes, such that the substitutions are made in a manner that optimizes efficiency with respect to cost, price, and margin.

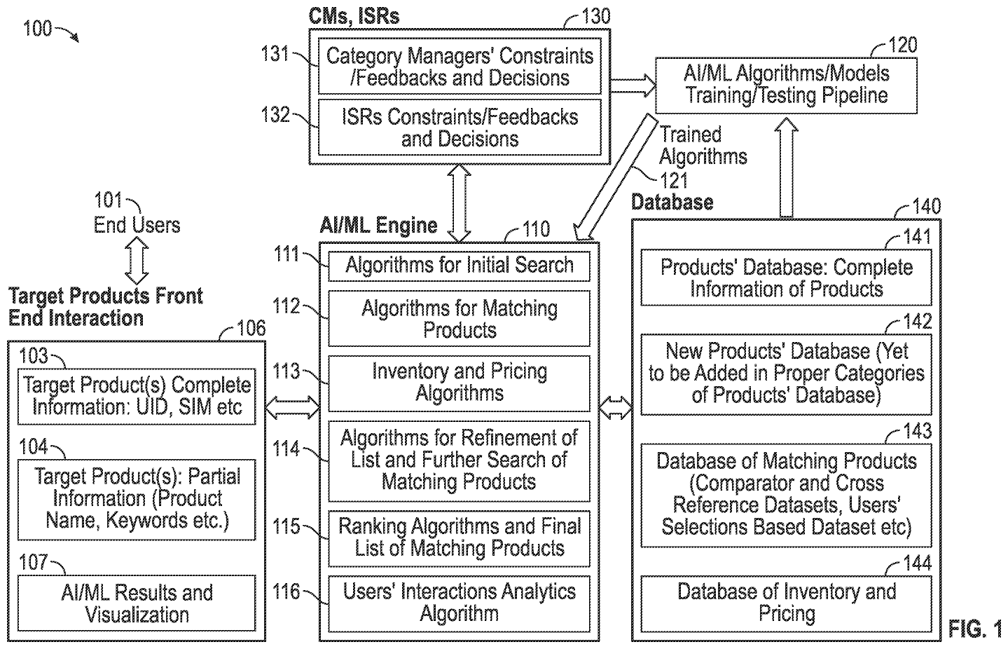

FIG. 1 is a block diagram representing an end user searching for a comparable substitute product via a distributor's product management computer system. For example, in FIG. 1, the product management computer system 100 initiates with an end user 101 inquiring about a target product in which that end user is interested. As an example, the end user 101 (which can be an internal sales representative for the distributor) desires to purchase a specific product (target product) but is willing to consider products that are suitable substitutes for the specified target product. The end user 101 may consider similar product (substitute product candidates) if, for instance, the substitute product is less expensive, but made by the same manufacturer.

The end user 101, for example, can be a customer of the distributor, an internal sales representative of the distributor, an agent of a principal, the principal, or the like. The target product identified by the end user 101 has one or more variable-value attributes; that is, attributes that can have different values. In some cases, an attribute of specific value constitutes complete information 103 that identifies the target product. For example, “complete information 103” on a target product can be constituted by an associated stock-keeping unit (commonly referred to as SKU), a subscriber identity model (commonly referred to as SIM or ICCID), or any identifier capable of fully representing an item's relevant attributes. A variable-value attribute of the target product may constitute only partial information 104 about the product if the end user 101 does not have complete information 103 that fully identifies the target product. In some cases, such partial information 104 about an item's attributes is insufficient to identify a known product within the product management computer system 100 or its supporting database component(s) 140. Such partial information 104 on an attribute of the target product might be the target product's tradename, its manufacturer or any other detail that helps describe the product but is insufficient to conclusively identify the target product.

The end user 101, in some instances, places constraints, conditions, and/or limitations on certain attribute values. The constraint, for example, may be a limitation that requires a certain, discrete value of a required attribute of the target product. Exemplarily, a product attribute might be constrained to a certain color, material of construction, binary value or numerical value. If the constraint on the product attribute is numerically based, the limitation imposed may limit the attribute value to (i) greater than, (ii) less than, (iii) equal to or (iv) within a prescribed value range.

As described, the intended purpose of inputting a target product's information into the distributor's product management computer system is to identify suitable substitute product candidates. Typically, the identified substitute product candidates will share common attributes, characteristics and/or fall within the same system category as the target product.

The distributor's product management computer system 100 can include multiple components. Additional components can be added, or fewer components can be utilized, without departing from this disclosure. The distributor's product management computer system 100 can be implemented on an electronic device. In at least one example, the distributor's product management computer system 100 can serve the purpose of providing substitute products candidates while factoring certain constraints such as deal breakers 524, pricing, inventory status 525, and preference via algorithms produced by machine learning. An additional factor can include the availability lead time of a product. It should be noted that the factors that have been initially described are not exhaustive; other factors can be added or removed.

Descriptive information about the target product is input to the distributor's product management computer system 100 by the end user 101, typically via a target products front end interaction component 106. After being input, the data received at the target products front end interaction component 106 is transmitted to the algorithm engine component 110. The algorithm engine component 110 processes the inputted data via algorithms that serve the purpose(s) of the distributor. In at least in one example, the algorithm engine component 110 comprises one or more algorithms. If multiple algorithms are utilized, each can be configured to serve a different purpose when searching for substitute product candidates. Exemplarily, the algorithms of the algorithm engine can include: (i) an algorithm for initial search 111; (ii) an algorithm for matching products 112; (iii) an algorithm for inventory and pricing 113; (iv) an algorithm for refinement of the matching list and further search of matching products 114; (v) an algorithm for ranking and compiling a final list of substitute products candidates 115; and (vi) an algorithm for user's interactions analytics 116. In at least one example, the different algorithms of the algorithm engine component 110 can be deployed depending on whether the data provided by the end user 101 is complete information 103 or partial information 104 identifying the target product.

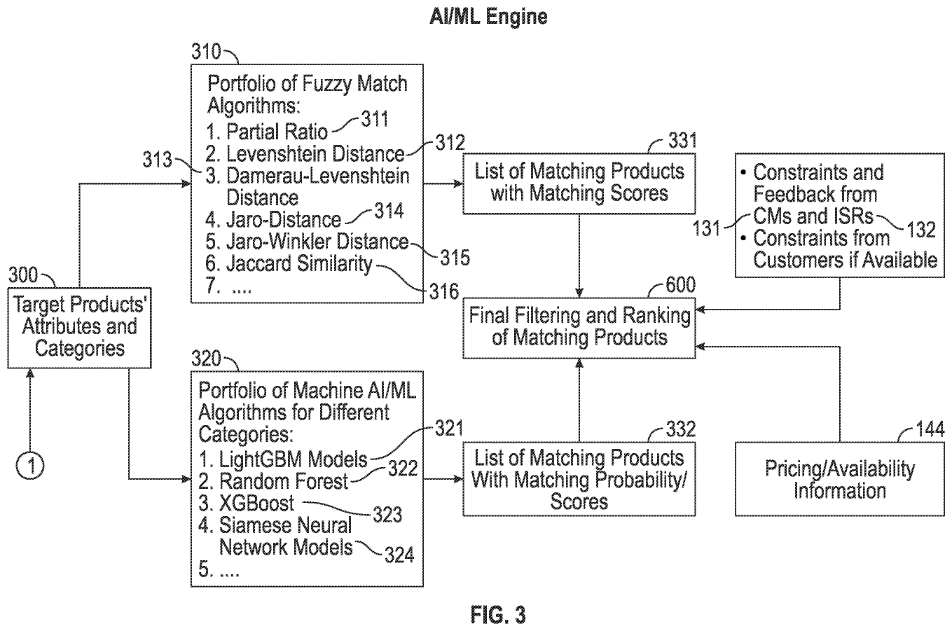

The algorithms for matching products 112 can include Fuzzy Match algorithms 310 such as Partial Ratio 311, Levenshtein Distance 312, Damerau-Levenshtein Distance 313, Jarro Distance 314, Jarro-Winkler Distance 315, and Jaccard Similarity 316 as depicted in FIG. 3. The algorithms for matching products 112 can further include LightGBM Models, Random Forest, XGBoost, and Siamese neural Network Models. The algorithms for matching products 112 can generate data representing a first set of substitute product candidates.

The Fuzzy Match algorithms 310 can be string matching algorithms for matching potential substitute products with target products. In at least one example, in matching target products via Fuzzy Match algorithms 310, the end user 101 can provide either complete information 103 or partial information 104 about the intended target product. In response, each algorithm of the Fuzzy Match algorithms 310 can produce its separate list of substitute product candidates. There can be some substitute product candidates yielded in one of the Fuzzy Match algorithms 310 that may not appear in the results of other Fuzzy Match algorithms 310.

In at least one example, the Fuzzy Match algorithms 310 can additionally allocate a match-score base on how similar the attributes of the substitute product candidates are with the attributes of the intended target product. The match-score can be defined by the equation of the algorithms within the Fuzzy Match algorithms 310. Because each algorithm within the Fuzzy Match algorithms 310 can produce its own match-score, replicated substitute product candidates from the different lists of Fuzzy Match algorithms 310. Some examples have the replicated substitute product candidate's similar score average that produces a one-to-one substitute product candidate and match-score. For substitute product candidates without replications across the various algorithms of the Fuzzy Match algorithms 310, there is no need to average singular matching products. The process of assigning a match-score for replicated substitute product candidates by averaging is not the only applicable process; other processes for assigning a match-score for replicated matching products can be appreciated. Specifically, a substitute product which appears in a list of a few Fuzzy Match Algorithms can have a matching score that is generated from remaining Fuzzy Match Algorithms and utilized in averaging process.

A particular algorithm within the Fuzzy Match algorithms 310 can be assigned to be the controlling algorithm for assigning a match-score. The controlling algorithm can be selected based on previous matchings and match-score performance of the now-selected controlling algorithm by a category manager or an authorized user. In at least one example, the specified controlling algorithm can be selected for a particular category or attribute of the target product. As an illustrative example, the Levenshtein Distance 312 algorithm can be selected as the controlling Fuzzy match algorithms for all target products relating to a light bulb category. Thus, the Levenshtein Distance 312 algorithm can assign the match-score that supersedes the match-scores of the identical matching substitute product candidates from the other algorithms of the Fuzzy Match algorithms 310.

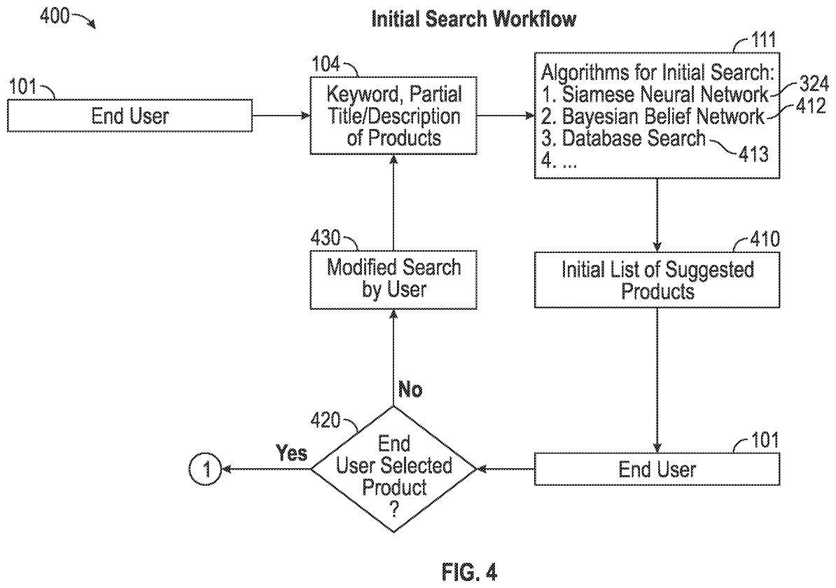

The algorithms for initial searching 111 can include Siamese Neural Network 324, Bayesian Belief Network 412, and Database Search 413 as depicted in FIG. 4. In at least one example, the algorithms for initial searching 111 can be used when partial information 104 is provide by the end user 101. The algorithms for initial searching 111 can be utilized in scenarios where the end user 101 provides partial information 104 about the target product. The algorithm for initial search 111 can include a process, illustrated in FIG. 4, to derive a target product of interest to the end user in order to ascertain the target product's complete information 103. The complete information 103 can then be input back into the algorithm engine component 110 of the distributor's product management computer system 100 to obtain a list and ranking of substitute product candidates.

The distributor's product management computer system 100 includes a machine learning component 120. The machine learning component 120 can communicate with the algorithm engine component 110. Training of the algorithms can be conducted in the machine learning component 120 to yield trained algorithms 121 which can be deployed in the algorithm engine component 110. The trained algorithms 121 can be fine-tuned algorithms of previously or currently deployed algorithms in the algorithm engine component 110 to produce more qualified pairing potentials or account for new data such as new products from a supplier or the end user 101.

The machine learning for the trained algorithms 121 within the machine learning component 120 are produced by inputting the algorithms from the algorithm engine component 110 by a Category Manager and Internal Sale Representative component 130, hereinafter referred to as CMISR component 130. Inputs for the machine learning component 120 can include category managers' constraints, feedback, and/or decisions 131 from the CMISR component 130 and databases from a database component 140. Both the CMISR component 130 and the database component 140 are components of the distributor's product management computer system 100.

The CMISR component 130 communicates with the algorithm engine component 110 and the machine learning component 120. The CMISR component 130 includes the category managers' constraints, feedbacks, and/or decisions 131; an inner sales representative' constraints, feedbacks, and/or decisions 132; and/or any constraints, feedbacks, and/or decisions of any personnel with authority. The CMISR component 130 can serve the purpose of assisting the machine learning component 120 in computing a trained algorithm 121 by supplying inputs. The inputs can be constraints, feedbacks, and/or decisions of the category manager 131, inner sales representative 132, or any personnel with authority.

The database component 140 can include a database of customers. The database of customers can include data on customers' preferred manufacturer preference, the customers' identity and association, the customers' purchase history and behavior on selecting suitable product candidates based on the variable-value attributes associated with the suitable product candidates.

The machine learning component 120 can include the algorithms in the algorithm engine component 110. To train the algorithms and produce refined algorithms, the algorithm engine component 110 can require input data. One input data, for example, can be the CMISR component 130. In at least one example, the CMISR component 130 can supply the machine learning component 120 new algorithms and approve or disapprove the trained algorithms 121. For example, disapproval of a trained algorithm 121 can be because that trained algorithm 121 yielded an unsuitable substitute product candidate or does not comport with the likeness of the CMISR component 130.

In order for the machine learning component 120 to be trained, the machine learning component 120 requires training data which can include data from the database component 140 to train the algorithms. The database component 140 includes at least one database. The database component 140 can also include a products' database 141, new products' database 142, matching products database 143, and inventory and pricing database 144. The products' database 141 (distributor database) can include complete product information or only certain products' descriptive data. In at least one example, the products' database 141 includes data representing products that have been designated a member of a category, wherein each member of a category has at least one common attribute and at least a portion of the products in a category are known substitutes for at least one other product in that category. The new products' database 142 includes new products yet to be added in proper categories of the products' database 141. The new products' database 142 can be products provided by a supplier or distributor. The database of matching products 143 can include comparator and cross reference datasets (datasets of previously paired target products and substitute products candidates and cross reference substitute products provided by manufacturers, other distributers and the like) and data of users' selections. The database of matching products 143 (distributor database) can include previous or current designation of products that are suitable substitute for another product.

The database component 140 can communicate with the algorithm engine component 110 directly to supply the algorithm engine component 110 with data from the database component 140 to execute its algorithms. The data from the database component 140 can be specifically the product descriptive data from the distributor database (products' database 141). At least in one example, the product descriptive data and/or data from the database component 140 can generate a first set of substitute product candidates.

The machine learning component 120 can then utilize the training data from the database component 140 to train the algorithms, which the CMISR component 130, in some examples, provide further input such as feedback and help produce a trained algorithm 121. The trained algorithm 121 can then be deployed or replace the antedated algorithms in the algorithm engine component 110.

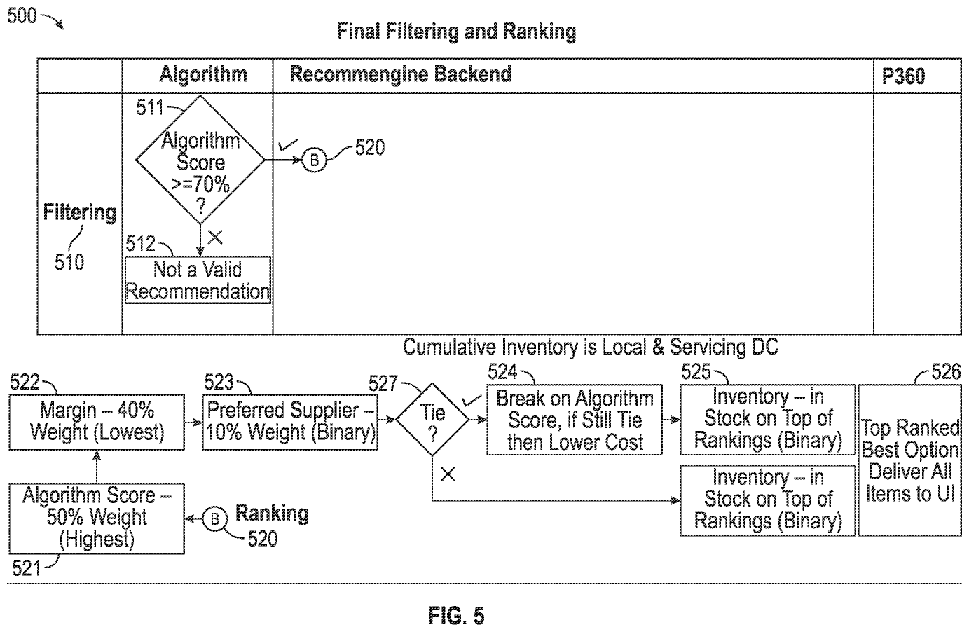

The ranking algorithms and final list of substitute product candidates 115 as depicted in FIG. 5 of the algorithm engine component 110 can retrieve data of the first set of substitute product candidates produced by the algorithms for matching products 112. The retrieved data can then be processed by the ranking algorithms and final list of substitute product candidates 115 which can utilize a constraint-based algorithm. The ranking algorithms and final list of substitute product candidates 115 can include a matching score weight 521, a price margin weight 522, a variable manufacture supplier consideration weight 523, deal breakers 524, inventory status 525, and final listing 526. The matching score weight 521 can be the match-scores of the substitute product candidates yielded by the algorithms for matching products 112 given a certain percentage. The price margin weight 522 include pricing, net profit margin, and the like. In other examples, the price margin weight 522 can include rebates, discounts, and any other factors affecting the price of the target products. The variable manufacture supplier consideration weight 523 can include a particular supplier or manufacturer that can be assigned a certain percentage. The matching score weight 521, price margin weight 522 and variable manufacture supplier consideration weight 523 can each be assigned a certain weight percentage that can total up to one hundred percent. As an example, the matching score weight 521 can be fifty percent, price margin weight 522 can be forty percent and variable manufacture supplier consideration weight 523 can be 10 percent. The weight percentage can exceed one hundred percent. Additional factors can be added or fewer components may be utilized, without departing from the teachings of this disclosure.

The price margin weight 522 can include a net product price to the distributor. A poor weigh score can be assigned or disqualify a substitute product candidate when the net product price to the distributor is too high or too low. The net product price to the distributor can be calculated by reducing or subtracting the substitute product candidate price from an applied vendor rebate and/or vendor discount. The net product price to the distributor can be calculated by adding an applied customer rebate and/or an applied customer discount to the substitute product candidate price.

In at least one example, the deal breaker 524 can include an exact value, a required greater than value, a required less than value, or a fixed range of value. The required values of the deal breaker 524 can be the match-score of the matching score weight 521, the margin weight 522, variable manufacture supplier consideration weight 523, and/or other additional factors. The required values of the deal breaker 524 can be defined by the category manager 131, inner sales representative 132, or any authorized personnel. If the deal breaker 524 does equal a defined value or within the defined range of value, the deal breaker 524 can disqualify the substitute product candidate from displaying on the final listing 526.

In some examples, the deal breaker 524 includes a rigid attribute of the target product, where the rigid attribute can be a certain attribute of the target product. The deal breaker 524, in some examples, also include an inflexible attribute value. The inflexible attribute value can require the substitute product candidates to have a fix, less than, greater than, or within a predefined range of value. The value can be a numerical value, characters, or attribute. If the attribute value of the substitute product candidate is outside the inflexible value of the identified rigid attribute, then the deal breaker can disqualify the substitute product candidate. A requirement of a ridge attribute's exact value-match between the target product and any substitute product candidates when the attribute is absolutely inflexible can also be require.

The inventory status 525 can include whether the substitute product candidate is in stock and can also include the quantity and age of the substitute product candidate. If the substitute product is not in stock, it may be eliminated as a substitute product candidate or not outputted to the end user 101. In other words, the out of stock substitute product candidate may be removed from appearing in the final listing 526. In other examples, the inventory status 525 can factor in lead time. In at least one example, lead time can be defined as the time necessary for processing, preparing materials, manufacturing, and delivery of an order. The inventory status 525, in at least one example, can rank a substitute product candidate based on its respective availability lead time. Where the availability lead time of a substitute product candidate exceeds an end user's 101 desired date of delivery which can constitute as an unacceptable long lead time, the respective substitute product candidate can thus be eliminated from the final listing 526.

The final listing 526 lists suitable substitute product candidates similar to the target product. The listing can be in numerical order. The numerical order can be based on an equation or the culmination of the matching score weight 521, price margin weight 522, and the variable manufacture supplier consideration weight 523 weight. The final listing 526 can include a filter that removes out of stock, substitute product candidates or deal breakers 524 from the final listing 526. The final listing 526 can be outputted from the distributor's product management computer system 100 on electric devices via the results and visualization element 107 of the target products front end interaction component 106.

The final listing 526 can rank, from highest to lowest, the substitute product candidates by the candidates' respective distributor percent product margin calculated as the summation of: (i) the stated product price (ii) minus any applied vendor rebate and any applied vendor discount (iii) plus any applied customer rebate and any applied customer discount and dividing the summation by the stated product price.

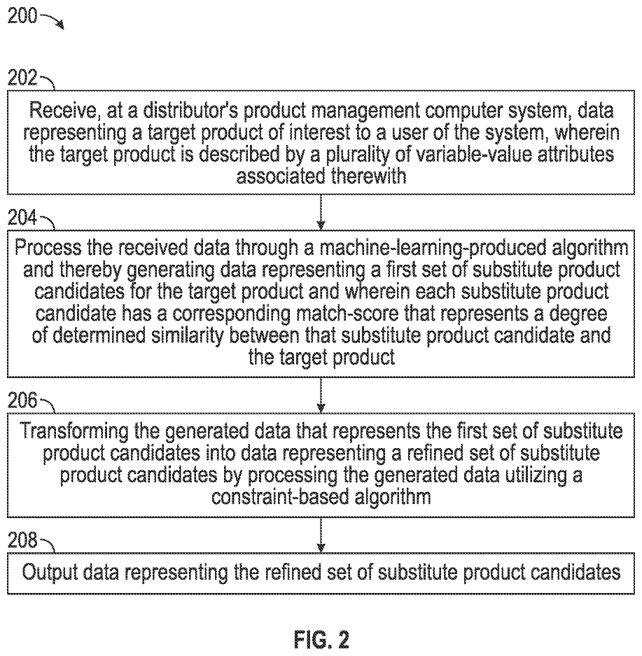

Referring to FIG. 2, a flowchart is presented in accordance with an exemplary embodiment. The method 200 is provided by way of example, as there are a variety of ways to carry out the method. The method 200 described below can be carried out using the configurations illustrated in FIGS. 1 and 3, for example, and various elements of these figures are referenced in explaining example method 200. Each block shown in FIG. 2 represents one or more processes, methods or subroutines, carried out in the example method 200. Furthermore, the illustrated order of blocks is illustrative only and the order of the blocks can change according to the present disclosure. Additional blocks can be added or fewer blocks can be utilized, without departing from this disclosure. The example method 200 can begin at block 202.

At block 202, data representing a target product of interests to the end user 101 of the distributor's product management computer system 100 is received. The data of the target product can be complete information 103 or partial information 104. In at least one example, the information can relay the attributes of the target product. The complete information 103 can be the SKU, UID, the SIM number, or any identifying mark capable of fully representing an item's attributes. Partial information 104 can be from when the end user 101 does not have complete information 103 about their intended target product. For example, the partial information 104 can be attributes of the target product such as the target product's name, manufacturers, characteristics, or any details capable of assisting in identifying the target product. After data representing a target product of interests to the end user 101 is received at block 202, the method can proceed to block 204.

At block 204, the received data is processed through one or more machined-learning-produced algorithms and thereby generating data representing a first set of probable and/or substitute product candidates for the target product. In at least one example, the machined-learning-produced algorithms can each serve a different purpose in searching for a substitute product. For example, the machined-learning-produced algorithms can include: (i) an algorithm for initial search 111; (ii) an algorithm for matching products 112; (iii) an algorithm for inventory and pricing 113; (iv) an algorithm for refrainment of the matching list and further search of matching products 114; (v) an algorithm for ranking and compiling a final list of substitute product candidates 115; and (vi) an algorithm for user's interactions analytics 116.

The algorithms for matching products 112 can include Fuzzy Match algorithms 310 which can include, but not limited to, Partial Ratio 311, Levenshtein Distance 312, Damerau-Levenshtein Distance 313, Jarro Distance 314, Jarro-Winkler Distance 315, and Jaccard Similarity 316 as depicted in FIG. 3. The algorithms for matching products 112 can further include LightGBM Models 321, Random Forest 322, XGBoost 323, and Simese neural Network Models 324 as depicted in FIG. 3. In some examples, prior to querying the distributor database for input data to the trained machine learning model, an algorithm can designate more than one products in the distributor database to a suitable substitute for another product in the distributor database. The algorithms for matching products 112 can generate data representing a first set of substitute product candidates.

It should be noted that the sequence in which the machined-learning-produced algorithms are executed can vary. In one example, the Fuzzy Match algorithms 310 can be executed in parallel with non-Fuzzy Match Algorithms such as LightGBM Models 321, Random Forest 322, XGBoost 323, and Simese neural Network Models 324. In other examples, the Fuzzy Match algorithms 310 and non-Fuzzy Match Algorithms can be executed in sequence, in conjunction, or in absence of one another.

The substitute product candidates can be associated with a match-score that reflects the degree of similarity between the substitute product candidate's to the target product. The match-score can be part of the equation in the machine-learning produced algorithms or a separate algorithm. The order of executing the match-score algorithm can be in sequence or in conjunction with the machine-learning produced algorithms. In some examples, the match-score can be calculated by taking the absolute value of the difference between the attribute's value of the substitute product candidate and the attribute's value of the target product divided by the attribute's value of the target price. After processing the received data into a first set of substitute product candidates with an associated match-score at block 204, the method can proceed to block 206.

At block 206, the processed data is transformed into data representing a refined set of probable substitute product candidates. The transformation can include processing the generated data utilizing a constraint-based algorithm, for example, a ranking algorithm and final list of substitute product candidates 115. The transformation can be conducted via an algorithm for ranking and producing a final list of substitute product candidates 115. The algorithm for ranking and producing a final list of substitute product candidates 115 can include a matching score weight 521, a price margin weight 522, a variable manufacture supplier consideration weight 523, deal breakers 524, inventory status 525, and final listing 526. The matching score weight 521 can be the match-scores of the substitute product candidates, yielded by the algorithms for matching products 112, given a certain percentage. The price margin weight 522 can include pricing, net profit margin, and the like. In other examples, the price margin weight 522 can include rebates and discounts of the target products. The variable manufacture supplier consideration weight 523 can include the supplier or manufacturer. The matching score weight 521, price margin weight 522, and variable manufacture supplier consideration weight 523 can each be assigned a certain weight percentage that can total up to one hundred percent. In at least one example, the matching score weight 521 can be fifty percent, price margin weight 522 can be forty percent, and variable manufacture supplier consideration weight 523 can be 10 percent. Additional factors can be added or fewer components can be utilized, without departing from this disclosure. Further, the weight percentage can exceed one hundred percent.

In one example, the deal breaker 524 can include an exact value, a required greater than value, a required less than value, or a fixed range of value. The required values of the deal breaker 524 can be the match-score of the matching score weigh 521, the margin weigh 522, variable manufacture supplier consideration weight 523, and/or other additional factors. The required values of the deal breaker 524 can be defined by the category manager 131, inner sales representative 132, or any authorized personnel. If the deal breaker 524 is trigger, in some examples, by the substitute product falling outside the required valve, the substitute product may not be displayed on the final listing 526.

The final listing 526 can list suitable substitute products compare to the target product. The listing can be in numerical order. The numerical order can be based on an equation or the culmination of the matching score weight 521, price margin weight 522, and the variable manufacture supplier consideration weight 523 weight. The final listing 526 can include a filter algorithm that disqualifies the out-of-stock substitute products or deal breakers 524 from be listed in the final listing 526. After transforming the generated data into a data representing a refined set of substitute product candidates at block 206, the method can proceed to block 208.

In some examples, block 202, block 204, and block 206 can be executed in advance and offline. The execution of the blocks 202, 204, and 206 can be conducted by an end user 101, category manager, or inner sales representative. The input data can be provided by the end user 101, category manager, or inner sales representative which can execute the method 200. Upon completion, the generated final list 526 can be stored in the database of matching products 143. Some benefits this provides is vastly increasing the speed of the distributor's product management computer system 100 by pre-pairing complete information 103 of the target products with a final list of substitute product candidates. Upon searching for the same complete information 103 of the target products, a pre-generated list can be provided without the requirement of executing the entire method in real-time.

At block 208, the data representing the refined set of substitute product candidates are outputted from the distributor's product management computer system 100 on electric devices. In some examples, the results and visualization element 107 of the target product front end interaction component 106 can output the final listing 606 to the end users 101.

FIG. 3 illustrates an example algorithm engine process that can be implemented in accordance with the present disclosure. The algorithm engine process 300 is provided by way of example, as there are a variety of ways to carry out the process. The algorithm engine process 300 can begin with an end user 101 inputting a desire target product's variable-value attribute. The variable-value attributes can be complete information 103 about the target product. For example, the complete information 103 can include a stock-keeping unit (commonly referred to as SKU), a subscriber identity model (commonly referred to as SIM or ICCID), or any identifying mark capable of fully representing an item's attributes. The variable-value attributes of the target product can also be a partial information 104 when the end user 101 does not have the complete information 103 about their intended target product. The partial information 104 can be an item's attributes insufficient to determine a known product in the system 100 or database component 140. In at least one example, the partial information 104 can be the attributes about the target product such as the target product's name, manufacturers, characteristics, or any details capable of assisting in identifying the target product. The substitute product candidates can share similar attributes, characteristics, or category with the target product.

After receiving the target product from the end user 101, the data can be variously weighed via trained machine learning model to determine substitute product candidates for the target product. In at least one example, the data can be transmitted to at least one subsets of algorithms. In at least one example, the data can be transmitted to at least two subsets of algorithms—one subset of algorithms can be Fuzzy Match algorithms 310 and the second subset of algorithms can be non-Fuzzy Match algorithms 320. The Fuzzy Match algorithms 310 can include, but not limited to, Partial Ratio 311, Levenshtein Distance 312, Damerau-Levenshtein Distance 313, Jarro Distance 314, Jarro-Winkler Distance 315, and Jaccard Similarity 316. The non-Fuzzy Match Algorithms can include, but not limited to, LightGBM Models 321, Random Forest 322, XGBoost 323, and Siamese neural Network Models 324.

Both subsets of algorithms can serve to inquiry and/or search for substitute product candidates that can either be similar or share a common attribute or a category. The Fuzzy Match algorithms 310 and the non-Fuzzy Match algorithms 320 can be executed in parallel or in sequence. The algorithms in both subsets can assign a match-score. The match-score can be defined as the substitute product degree of determined similarity between to the target product and also be a numerical value.

After execution, the Fuzzy Match algorithms 310 can produce a Fuzzy Match list of similar product candidates with match-score 331 of the Fuzzy Match algorithms 310. The non-Fuzzy Match algorithms 320, likewise, after execution, can produce a list of similar product candidates with match-score 332. Both the Fuzzy Match list of similar product candidates with match-score 331 of and the non-Fuzzy match list of similar product candidates with match-score 332 can be sent to the ranking algorithms and final list of substitute product candidates 115 to filter and rank a final list of substitute product to output to the end user 101. The inventory and pricing database 144 can be inputted into the algorithm for ranking and compiling a final list of matching substitute products candidates 115 to execute the algorithm. The CMISR Component can be inputted into the algorithm for ranking and compiling a final list of matching substitute products candidates 115 to supply the Category mangers' constraints, feedbacks, and/or decisions 131, the Inner sales representative' constraints, feedbacks, and/or decisions 132, or any authorized personnel's constraints, feedbacks, and/or decisions. The algorithm for ranking and compiling a final list of matching substitute products candidates 115 can produce a final listing 606 of the top ranked or best option of substitute candidates. The final listing 606 can be ranked based on the substitute product candidate's match-scores.

FIG. 4 illustrates an example initial search process for partial information of a target product that can be implemented in examples disclosed herein. The initial search process 400 can begin with the end user 101 when the end user 101 only has partial information 104 on a target product. The end user 101 can begin the initial search process 400 by inputting a partial information 104. For example, the partial information 104 can be the attributes about the target product such as the target product's name, manufacturers, characteristics, or any details capable of assisting in identifying the target product. The partial information data can then be inputted into the algorithms for initial search 111 of the algorithm engine component 110.

The algorithms for initial search 111 can include more than one algorithm such as a Siamese Neural Network 324, Bayesian Belief Network 412, and Database Search 413. The algorithms for initial search 111 can produce an initial list of suggested products 410. The initial list of suggested products 410 can be potential substitute product candidates. The initial list of suggested products 410 can then be outputted to the end user 101 via the distributor's product management computer system on an electronic device. The end user 101 can then select a substitute product candidate from the initial list of suggested products 410. If the end user 101 selects a substitute product candidate 420 from the initial list of suggested products 410, the complete information 103 of the selected substitute product candidate is now derived. The initial search process 400 can input the complete information 103 into the algorithm engine component 110 component of the distributor's product management computer system 100 to produce a final list of top ranked substitute product candidates.

If the end user 101 does not select a substitute product candidate 420, the initial search process 400 can proceed to having the end user 101 modifying the search 430 by providing additional information about the target product or modifying the partial information 104 provided by the end user 101. The now modified partial information can be repeated through the process of inputting the now modified partial information into the algorithms for initial search 111, where the initial list of suggested products 410 can be reproduced and outputted to the end user 101. The end user can then select a substitute product candidate from the list of suggested products 410 or provide additional modification of the partial information 104 into the algorithms for initial search 111 until the end user selects a substitute product candidate from the list of suggested products 410. The selected substitute product candidate can then be inputted into the algorithm engine component 110 of the distributor's product management computer system 100 to produce a final list of top ranked substitute product candidates.

FIG. 5 illustrates an exemplary final filtering and ranking process 500 that can be implemented in examples disclosed herein. It should be noted that the following example is not the sole process for a final filtering and ranking of substitute product candidates and variations of the process disclosed can vary. The final filtering and ranking process 500 can filters and compile a ranked listing of substitute product candidates yielded from the algorithms for matching products 112. Upon producing the ranked listing of substitute product candidates, the final filtering and ranking process 500 can output the results to the end user 101 on an electronic device.

The final filtering and ranking process 500 can begin with a pre-filtering process 510 where substitute product candidates 420 are inputted. The pre-filtering process 510, in at least one example, can include an algorithm score 511 which is defined to filter out substitute product candidate 420 that has a match-score below or fails to meet a certain threshold. In some examples, the algorithm score 511 can be set to require a match-score from the substitute product candidate 420 of greater than or equal to seventy percent. Where the substitute product candidate 420 fails to meet the match-score threshold of the algorithm score 511, the substitute product candidate 420 can be proceeded to the not a valid recommendation 512 or removed from the final filtering and ranking process. Where the substitute product candidate 420 does meet the match-score threshold of the algorithm score 511, the substitute product candidate 420 can be proceeded to a final ranking 520 of the final filtering and ranking process 500.

Factors the final ranking 520 of the final filtering and ranking process 500 can take into consideration includes a matching score weight 521, price margin weight 522, variable manufacture supplier consideration weight 523, deal breakers 524, and inventory status 525.

The matching score weight 521 can be the match-scores of the substitute product candidates, yielded by the algorithms for matching products 112, given a certain percentage. The price margin weight 522 can include pricing, net profit margin, and the like. In other examples, the price margin weight 522 can include rebates, discounts, and any other factors affecting the price of the target products. The variable manufacture supplier consideration weight 523 can include a particular supplier or manufacturer that can be assigned a certain percentage. The matching score weight 521, price margin weight 522, and variable manufacture supplier consideration weight 523 can each be assigned a certain weight percentage that can total up to one hundred percent. In at least one example, the matching score weight 521 can be fifty percent, price margin weight 522 can be forty percent, and variable manufacture supplier consideration weight 523 can be 10 percent. The weight percentage, in other examples, can exceed one hundred percent. Additional factors can be added or fewer components can be utilized, without departing from this disclosure.

In one example, the deal breaker 524 can include an exact value, a required greater than value, a required less than value, or a fixed range of value. The required values of the deal breaker 524 can be the match-score of the matching score weight 521, the margin weight 522, variable manufacture supplier consideration weight 523, and/or other additional factors. The required values of the deal breaker 524 can be defined by the category manager 131, inner sales representative 132, or any authorized personnel. In at least one example, if the deal breaker 524 is not within a defined value or range of value, the deal breaker can disqualify the substitute product candidate from displaying on the final listing 526.

The inventory status 525 can include whether the substitute product candidate is in stock and can also include the quantity and age of the substitute product candidate of interest. In at least in one example, if the substitute product is not in stock, it will not be displayed or outputted to the end user 101. In other words, the substitute product candidate can be disqualified from appearing on the final listing 526.

The final listing 526 can list suitable substitute product candidates similar to the target product. The listing can be in numerical order. The numerical order can be based on an equation or the culmination of the matching score weight 521, price margin weight 522, and the variable manufacture supplier consideration weight 523 weight. The final listing 526 can include a filter that disqualifies out-of-stock substitute product candidates, for example deal breakers 524 which removes disqualified substitute product candidates from the final listing 526. The final listing 526 can be outputted from the distributor's product management computer system 100 on electric devices.

The final filtering and ranking process 500 can proceed at 520 where different factors of the substitute product candidates can be considered. The first factor can be the matching score weight 521. The second factor can be the price margin weight 522. The third factor 523 can be the variable manufacture supplier consideration weight 523. The factors can be weighed chronologically or have different order sequence. A final score can be compiled by the summation of each factor and its attributing weight value. After each substitute product candidate's factors are weighed and yield its final score, the final filtering and ranking process 500 then checks for any ties at 527. If there are no ties, the substitute product candidates with its final score can proceed to check if the substitute product candidates are in stock at 525. If the substitute product candidate is out of stock at 525, then the substitute product candidate can be removed from the final list 526. If there is at least one tie the final filtering and ranking process 500, the process can proceed to 524 where deal breakers can be applied. In some examples, the deal breakers can be applied when there are no ties or before 527, the tie inquiry.

In one example, the deal breaker 524 can include an exact value, a required greater than value, a required less than value, or a fixed range of value. The required values of the deal breaker 524 can be the match-score of the matching score weight 521, the margin weight 522, variable manufacture supplier consideration weight 523, and/or other additional factors. The required values of the deal breaker 524 can be defined by the category manager 131, inner sales representative 132, or any authorized personnel. If the deal breaker 524 is trigger, in some examples, by the substitute product falling outside the required valve, the substitute product can be disqualified from the final listing 526.

The final filtering and ranking process 500 can then proceed to 525 where the process proceed to check if the substitute product candidates are in stock at 525. If the substitute product candidate is out of stock, then the substitute product candidate can be removed from appearing on the final list 526. The final list 526, can list in a top ranked fashion of the best options of the substitute product candidates.

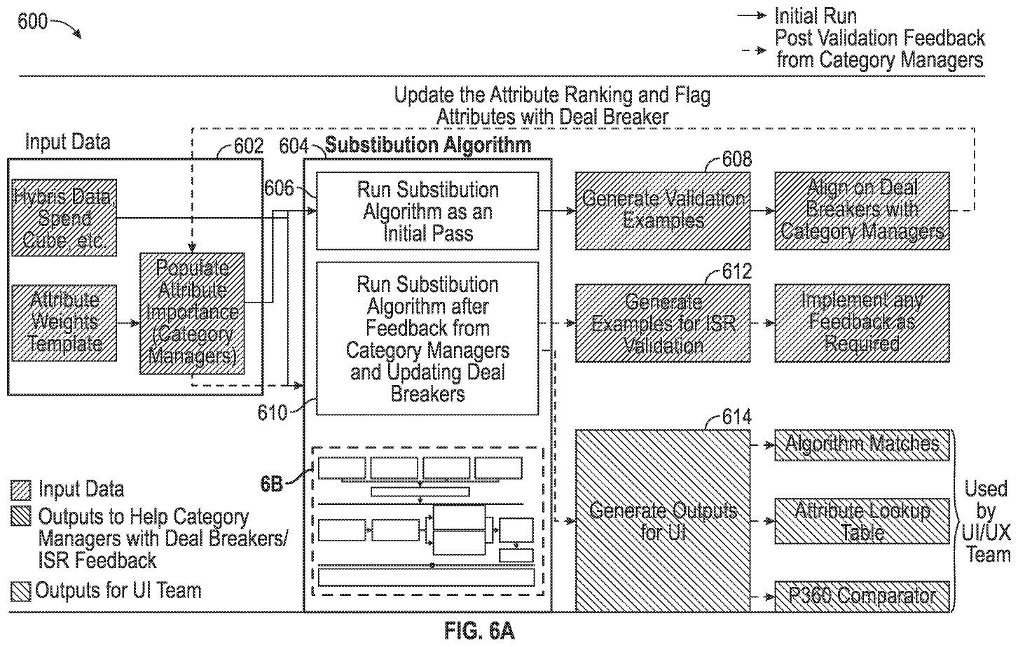

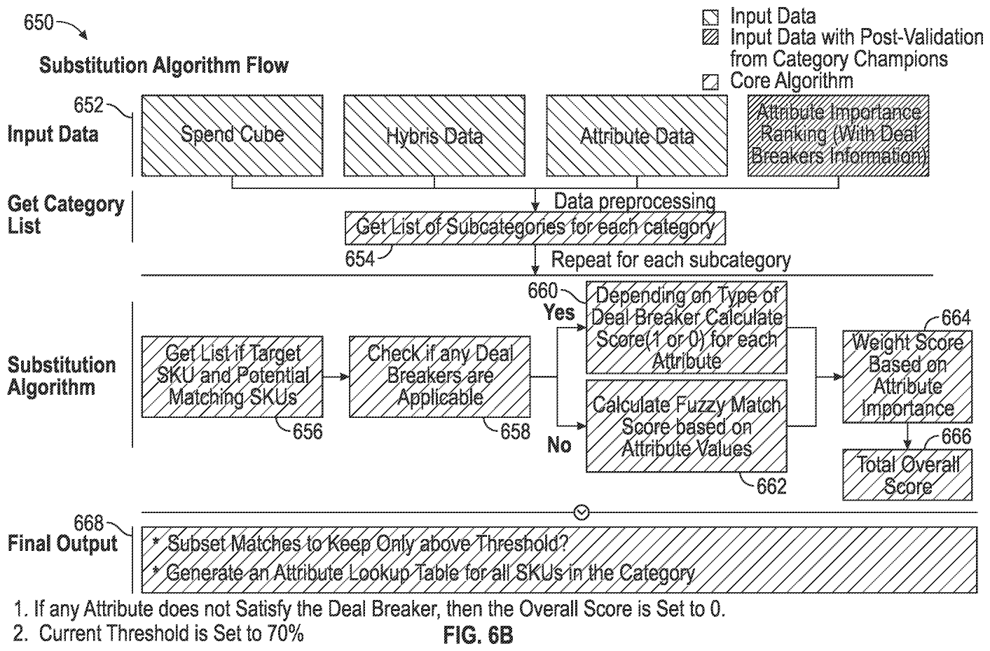

FIG. 6A illustrates an example flow 600 for utilizing fuzzy matching to identify substitute products for a target product. In the example flow 600, input data 602 is provided to the substitution algorithms 604. The input data 602 can include applicable data for identifying a substitute product for a target product, such as the data described herein. In particular, the input data 602 can include hybris data, spend cube, attribute weights templates, and populate attribute importance data.

The substitution algorithms 604, can run as an initial pass at 606. In running as an initial pass, the substitution algorithms can be run without applicable feedback information; e.g., feedback from category managers and feedback from updating deal breaker 524. The output from running the substitution algorithms 604 through an initial pass can include validation examples 608. The validation examples 608 can be aligned with the deal breakers 524 and/or the category managers. In turn, the attribute rankings and flag attributes can be updated based on the aligned validation examples.

The substitution algorithms 604 can also be applied to the input data 602 after the initial pass. Specifically, the substitution algorithms 604 can be applied to the input data 602 at 610 after feedback is provided from the category managers and the deal breakers 524 are updated. The application(s) of the substitution algorithms after the initial pass can be used to generate examples for Internal Sales Representative (herein “ISR”) validation 612. In turn, these examples can implement applicable ISR feedback.

Further, application(s) of the substitution algorithms 604 after the initial pass can be used to generate output for reproduction through user interfaces at 614. For example, the substitute algorithms can generate output for algorithm matches, attribute lookup table(s), and P360 comparator.

FIG. 6B illustrates an example flow 650 of implementing substitute algorithms for identifying substitute products of a target product. In the example flow 650, input data 652 is preprocessed and applied at 654 to identify a list of subcategories for each category. This process can be repeated for each subcategory.

Once the subcategories are identified for each category, the substitution algorithm is applied. In particular, at 656, a target SKU and potential matching SKUs to the target SKU are identified. At 658, the target SKU and the potential matching SKUs are checked to identify whether any deal breakers are applicable. If applicable deal breakers are identified, then at 660, a score is calculated for each attribute based on the type of deal breakers that are identified. If applicable deal breakers are not identified, then at 662, a fuzzy match score is calculated based on the attribute values. The scores, at 664, are weighted across the attributes based on attribute importance. Then, at 666, the total overall score is calculated. At 668, the final output is generated based on the total overall score. This score can be used in identifying suitable substitute products for the target product; e.g., as part of the final output. For example, matches can be kept based on their relationship; e.g., above, a specific threshold. Further, an attribute lookup table can be generated for all SKUs in the category based on the total overall score.

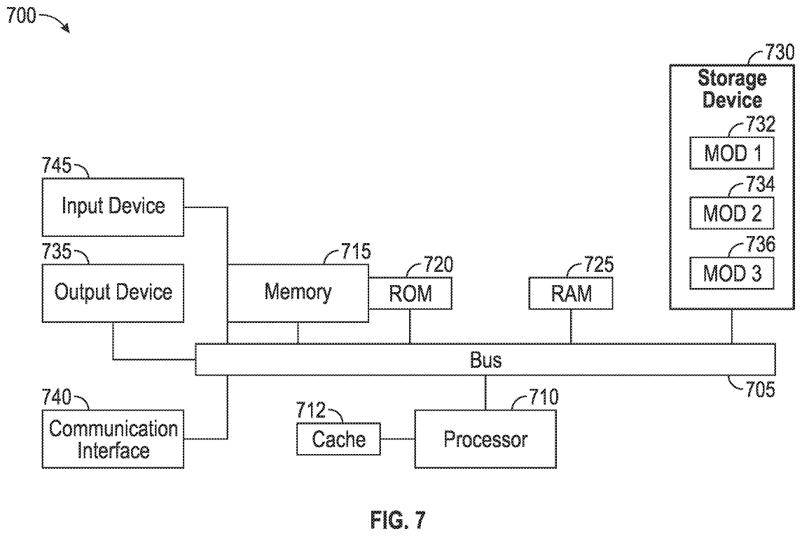

The disclosure now turns to FIG. 7 which illustrates an example of a processor-based computing system 700 wherein the components of the system are in electrical communication with each other using a bus 705. The computing system 700 can include a processing unit (CPU or processor) 710 and a system bus 705 that may couple various system components including the system memory 715, such as read only memory (ROM) 720 and random-access memory (RAM) 725, to the processor 710. The computing system 700 can include a cache 712 of high-speed memory connected directly with, in close proximity to, or integrated as part of the processor 710. The computing system 700 can copy data from the memory 715, ROM 720, RAM 725, and/or storage device 730 to the cache 712 for quick access by the processor 710. In this way, the cache 712 can provide a performance boost that avoids processor delays while waiting for data. These and other modules can control the processor 710 to perform various actions. Other system memory 715 may be available for use as well. The memory 715 can include multiple different types of memory with different performance characteristics. The processor 710 can include any general-purpose processor and a hardware module or software module, such as (i) “module 1” 732; (ii) “module 2” 734, and (iii) “module 3” 736 stored in the storage device 730, configured to control the processor 710 as well as a special-purpose processor where software instructions are incorporated into the actual processor design. The processor 710 can essentially be a completely self-contained computing system, containing multiple cores or processors, a bus, memory controller, cache and the like. A multi-core processor may be symmetric or asymmetric.

To enable user interaction with the computing system 700, an input device 745 can represent any number of input mechanisms, such as a microphone for speech, a touch-protected screen for gesture or graphical input, keyboard, mouse, motion input, speech and so forth. An output device 735 can also be one or more of a number of output mechanisms known to those of skill in the art. In some instances, multimodal systems can enable a user to provide multiple types of input to communicate with the computing system 700. The communications interface 740 can govern and manage the user input and system output. There may be no restriction on operating on any particular hardware arrangement and therefore the basic features here can easily be substituted for improved hardware or firmware arrangements as they are developed.

The storage device 730 can be a non-volatile memory and can be a hard disk or other types of computer readable media which can store data that are accessible by a computer, such as magnetic cassettes, flash memory cards, solid state memory devices, digital versatile disks, cartridges, random access memory, read only memory, and hybrids thereof.

As discussed above, the storage device 730 can include the software modules 732, 734, 736 for controlling the processor 710. Other hardware or software modules are contemplated. The storage device 730 can be connected to the system bus 705. In some embodiments, a hardware module that performs a particular function can include a software component stored in a computer-readable medium in connection with the necessary hardware components, such as the processor 710, bus 705, output device 735, and so forth, to carry out the function. For clarity of explanation, in some instances the present technology may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general-purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that can be used to store instructions, information used, and/or information created during methods according to described examples include magnetic or optical disks, flash memory, USB devices provided with non-volatile memory, networked storage devices and the like.

Devices implementing methods according to these disclosures can comprise hardware, firmware and/or software, and can take any of a variety of form factors. Typical examples of such form factors include laptops, smart phones, small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

Claim language reciting “at least one of” refers to at least one of a set and indicates that one member of the set or multiple members of the set satisfy the claim. For example, claim language reciting “at least one of A and B” means A, B, or A and B.

1. A distributor's product management computer system comprising:
one or more processors; and
a computer-readable medium comprising instructions stored therein, which when executed by the one or more processors, cause the one or more processors to:
receive data representing a target product of interest to a user of the system, wherein the target product is described by a plurality of variable-value attributes associated therewith;
process the received data through a machine-learning-produced algorithm and thereby generating data representing a first set of substitute product candidates for the target product and wherein each substitute product candidate has a corresponding match-score that represents a degree of determined similarity between that substitute product candidate and the target product;
transform the generated data that represents the first set of substitute product candidates into data representing a refined set of substitute product candidates by processing the generated data utilizing a constraint-based algorithm; and
output data representing the refined set of substitute product candidates.

2. The distributor's product management computing system as recited in claim 1, wherein the instructions further cause the one or more processors to ranks the substitute product candidates according to the respective match-scores of the substitute product candidates as part of processing the generated data utilizing the constraint-based algorithm.

3. The distributor's product management computing system as recited in claim 1, wherein the instructions further cause the one or more processors to disqualify at least one substitute product candidate for failure to meet a match-score threshold value as part of processing the generated data utilizing the constraint-based algorithm based on the respective match-scores of the each substitute product candidate.

4. The distributor's product management computing system as recited in claim 1, wherein the instructions further cause the one or more processors to:
implement a condition that each substitute product candidate has a variable-value attribute in common with the target product and that the value of the attribute of each substitute product candidate is within a prescribed range of the value of that attribute of the target product.

5. The distributor's product management computing system as recited in claim 1, wherein the instructions further cause the one or more processors to:
utilize product descriptive data from a distributor database as input data processed by the machine-learning-produced algorithm to generate the first set of substitute product candidates, the database comprising data representing products described at least partially by a Stock Keeping Unit (SKU) and wherein each SKU comprises a plurality of variable-value attributes that are respectively populated with a product-descriptive value.

6. The distributor's product management computing system as recited in claim 1, wherein the instructions further cause the one or more processors to:
utilize product descriptive data from a distributor database as input data processed by the machine-learning-produced algorithm to generate the first set of substitute product candidates, the database comprising data representing products described at least partially by a Stock Keeping Unit (SKU) and wherein each SKU comprises a plurality of variable-value attributes that are respectively populated with a product-descriptive value.

7. The distributor's product management computing system as recited in claim 1, wherein the instructions further cause the one or more processors to:
utilize product descriptive data from a distributor database as input data processed by the machine-learning-produced algorithm to generate the first set of substitute product candidates, the database comprising data representing products that have been designated a member of a category, wherein each member of a category has at least one common attribute and at least a portion of the products in a category are known substitutes for at least one other product in that category.

8. The distributor's product management computing system as recited in claim 7, wherein the instructions further cause the one or more processors to:
designate, prior to querying the distributor database for input data to the machine-learning-produced algorithm, a plurality of products in the distributor database a suitable substitute for another product in the distributor database.

9. The distributor's product management computing system as recited in claim 1, wherein the instructions further cause the one or more processors to:
receive data derived from user input intended to identify a target product of interest, said user input being insufficient to determine a known product represented in the system; and
process the data derived from the user input with at least one string matching algorithm and thereby determining a probable identity of the intended target product and using system data representative of that probably intended target product as input data in a target product query of the distributor's product management computer system.

10. The distributor's product management computing system as recited in claim 1, wherein the instructions further cause the one or more processors to:
variously weight the plurality of variable-value attributes of the target product prior to processing using the machine-learning-produced algorithm to determine substitute product candidates for the target product.

11. The distributor's product management computing system as recited in claim 1, wherein the instructions further cause the one or more processors to:
identify a rigid attribute of the target product having an inflexible attribute value; and
disqualify, from the set of substitute product candidates, each included product having an attribute value outside the inflexible value of the identified rigid attribute.

12. The distributor's product management computing system as recited in claim 11, wherein the inflexible value of the rigid attribute is a predetermined value range.

13. The distributor's product management computing system as recited in claim 11, wherein the instructions further cause the one or more processors to:
implement a condition, via the machine-learning-produced algorithm's generation of substitute product candidates, that a rigid attribute's exact value-match between the target product and any substitute product candidates when the attribute is absolutely inflexible.

14. The distributor's product management computing system as recited in claim 11, wherein the instructions further cause the one or more processors to:
implement a condition that any substitute product candidate of a target product generated by the machine-learning-produced algorithm has a rigid attribute's value that is less than or equal to a predetermined inflexible value of the rigid attribute.

15. The distributor's product management computing system as recited in claim 11, wherein the instructions further cause the one or more processors to:
implement a condition that any substitute product candidate of a target product generated by the machine-learning-produced algorithm has a rigid attribute's value that is greater than or equal to a predetermined inflexible value of the rigid attribute.

16. The distributor's product management computing system as recited in claim 1, wherein the constraint is a net product price to the distributor that affects at least one of: (i) ranking the substitute product candidates by net product price to the distributor and (ii) eliminating at least one of the substitute product candidates from the refined set as one of (a) too high of a net product price to the distributor and (b) too low of a net product price to the distributor.

17. The distributor's product management computing system as recited in claim 16, wherein a net product price to the distributor is calculated by subtracting from a stated product price any one of: (i) an applied vendor rebate and (ii) an applied vendor discount.

18. The distributor's product management computing system as recited in claim 16, wherein a net product price to the distributor is calculated by adding to a stated product price any one of: (i) an applied customer rebate and (ii) an applied customer discount.

19. The distributor's product management computing system as recited in claim 1, wherein the instructions further cause the one or more processors to:
rank, from highest to lowest, the substitute product candidates by a candidates' respective distributor percent product margin calculated as a summation of: (i) a stated product price (ii) minus any applied vendor rebate and any applied vendor discount (iii) plus any applied customer rebate and any applied customer discount and dividing the summation by the stated product price.

20. The distributor's product management computing system as recited in claim 1, wherein the constraint is product availability lead time that affects at least one of: (i) ranking the substitute product candidates by each candidate's respective availability lead time and (ii) eliminating at least one of the substitute product candidates based on a candidate's unacceptably long lead time.

21. The distributor's product management computing system as recited in claim 1, wherein the instructions further cause the one or more processors to:
rank the substitute product candidates based on each substitute product candidate's respective match-score generated by a trained machine learning model.

22. The distributor's product management computing system as recited in claim 1, wherein the instructions further cause the one or more processors to:
rank the substitute product candidates based on each substitute product candidate's respective match-score generated by a trained machine learning algorithm.

23. The distributor's product management computing system as recited in claim 22, wherein the match-score between a substitute product candidate and the target product is calculated utilizing any one machine learning algorithm of the following types: (i) Levenshtein Distance, (ii) Partial Ratio, (iii) Jarro-Winkler Distance, (iv) Jarro Distance, (v) Damerau-Levenshtein Distance, and (vi) Jaccard Similarity.

23. The distributor's product management computing system as recited in claim 22, wherein the match-score between a substitute product candidate and the target product is determined by a degree to which the attribute values of the substitute product candidate match the attribute values of the target product for each attribute common there between.

24. The distributor's product management computing system as recited in claim 22, wherein an attribute value between a substitute product candidate and the target product is calculated by taking an absolute value of a difference between the attribute's value of the substitute product candidate and the attribute's value of the target product divided by the attribute's value of the target product.
